(19) United States
(12) Patent Application Publication
(10) Pub. No.: US 2022/0338501 A1
(43) Pub. Date: Oct. 27, 2022

(54) METHOD FOR PRODUCING TRANSPARENTLY SUGAR-COATED CHEWING GUM HAVING COLOURED CARBOHYDRATE PARTICLES

(71) Applicant: SÜDZUCKER AG, Mannheim (DE)

(72) Inventors: Bernd Hasslinger, Mannheim (DE); David Richfield, Mannheim (DE); Roland Zsembery, Mannheim (DE)

(21) Appl. No.: 17/761,568

(22) PCT Filed: Sep. 10, 2020
(86) PCT No.: PCT/EP2020/075404

§ 371 Date: Mar. 17, 2022

(30) Foreign Application Priority Data
Sep. 20, 2019 (DE) 10 2019 214 372.5

(51) Int. Cl. A23G 4/20; A23G 4/10

(52) U.S. Cl. CPC A23G 4/20; A23G 4/10; A23V 2002/00

(57) ABSTRACT

The present invention relates to a method for producing transparently sugar-coated chewing gum having a heterogeneously structured chewing gum core and a transparent sugar-coated surface layer enveloping this core, wherein colored carbohydrate particles, which are scattered on and rolled into a surface of the extruded shaped chewing-gum body before the sugar-coating, are visible through the transparent sugar-coated surface layer.

The present invention relates to a method for producing transparently sugar-coated chewing gum having a heterogeneously structured chewing gum core and a transparent sugar-coated surface layer enveloping this core, wherein colored carbohydrate particles, which are scattered on and rolled into a surface of the extruded shaped chewing-gum body before the sugar-coating, are visible through the transparent sugar-coated surface layer, and chewing gum produced according to this method.

Colored chewing gum cores, including multicolored chewing gum cores, are known in the prior art. For example, WO 01/89312 discloses chewing gum cores that can have several differently colored regions. For this purpose, at least two differently colored chewing gum masses are prepared and extruded via a co-extruder, so that differently colored layers, stripes, a marbling or a core enclosed by a differently colored layer are obtained. For the production of multicolored chewing gum cores, more than one extruder or one co-extruder and, depending on the number of colors, several mixers or more time for the sequential production of the individual colored chewing gum masses are therefore required. The production of multi-colored chewing gum cores is therefore associated with considerable expenditure on equipment, costs and/or time.

Hard, crunchy coatings of chewing gum cores, so-called sugar-coated surface layers, are also known in the prior art. Until now, such coatings have usually been produced with color pigments, with titanium dioxide, calcium carbonate or starch being used for white coatings and other food colors being used for colored coatings. Coating colored chewing gum cores transparently so that the coloring of the cores can be seen through the coating is also known from the prior art. For example, the above-mentioned WO 01/89312 also describes a transparent coating of the multicolored chewing gum cores, mainly consisting of sorbitol, wherein binding agents such as gum arabic, sweeteners, flavorings and the like can also be contained.

WO 2016/166092 discloses transparently sugar-coated confectionery products, the core of the confectionery products comprising one or more materials visible through the coating, wherein these materials can have different colors. The materials, which may have different colors, are integrally distributed throughout the entire core. The provision of such products is expensive on the one hand, since a comparatively large amount of colored materials is required, and on the other hand at least certain groups of consumers deem that the crunchiness is not sufficiently pronounced.

The problem upon which the present invention is based is to provide chewing gum that is organoleptically and visually particularly appealing, in particular with improved crunchiness, which is also particularly simple and inexpensive to produce.

The present invention solves the technical problem upon which it is based by providing the teaching of the independent claims.

In particular, the present invention relates to a method for producing transparently sugar-coated chewing gum, having a heterogeneously structured chewing gum core and a transparent sugar-coated surface layer enveloping this core, comprising the following method steps, in particular consisting of the following method steps:

a) providing chewing gum core components, in particular at least one chewing gum base and at least one first carbohydrate, colored carbohydrate particles with a particle diameter of 0.2 to 2 mm, and a transparent sugar-coating medium containing at least one second carbohydrate,
b) mixing and kneading the chewing gum core components to obtain a chewing gum core mass,
c) extruding the chewing gum core mass to obtain an extruded shaped chewing gum body,
d) scattering the colored carbohydrate particles on a surface of the extruded shaped chewing-gum body,
e) rolling the shaped chewing-gum body scattered with colored carbohydrate particles,
f) cutting the rolled shaped chewing-gum body obtained in step e) to obtain heterogeneously structured chewing-gum cores,
g) sugar-coating the heterogeneously structured chewing-gum cores obtained in step f) with the transparent sugar-coating medium and
h) obtaining transparently sugar-coated chewing gum, having a heterogeneously structured chewing gum core.

In connection with the present invention, a heterogeneously structured chewing gum core is understood to be a shaped body made of extruded chewing gum core mass, on the surface of which colored carbohydrate particles have been scattered, which were pressed into the chewing gum core mass by the subsequent rolling of the shaped chewing-gum body provided according to the invention. According to the invention, the colored carbohydrate particles are applied to the surface of the shaped chewing-gum body and are accordingly not or not completely surrounded by the chewing gum core mass. As a result, even after the rolling provided according to the invention, preferably the entire particle surface that is basically visible from a certain perspective and given by the maximum circumference of the colored carbohydrate particles or at least a significant portion thereof is visible. Assuming an essentially spherical shape of the colored carbohydrate particles provided in a preferred embodiment, the entire hemispherical surface or a significant portion thereof is therefore visible. The visibility of the colored carbohydrate particles is retained even after the coating of the heterogeneously structured chewing gum cores with the transparent sugar-coating medium provided according to the invention. The colored carbohydrate particles are characterized by a color that deviates from the color of the extruded chewing gum core mass, so that a heterogeneously structured chewing gum core, in particular a visually and structurally heterogeneous chewing gum core, is formed.

The present invention therefore advantageously provides a method with which transparent, in particular see-through, sugar-coated chewing gum having a heterogeneously structured chewing gum core can be produced particularly simply and inexpensively, in particular without using a plurality of extruders or a co-extruder or a large number of mixers. By scattering the colored carbohydrate particles on the extruded shaped chewing-gum body, an at least two-colored surface of the shaped chewing-gum body can be produced in a simple manner, which remains visible through the transparent sugar-coated surface layer. By scattering the colored carbohydrate particles on a surface of the extruded chewing gum core mass according to the invention and then rolling the extruded chewing gum core mass according to the invention in the colored carbohydrate particles, these are particularly clearly visible compared to carbohydrate particles mixed with the chewing gum core mass, which are integral and therefore enveloped by the chewing gum core mass in the core, so that the transparently sugar-coated chewing gum obtained is also visually appealing. With a comparatively small amount of colored carbohydrate particles, the present invention therefore makes it possible to achieve a particularly distinct optical effect, in particular a distinct color effect, in relation to the amount of chewing gum core mass used, since all the colored carbohydrate particles introduced into the process are visible on the surface of the chewing gum core and contribute to the visual perception of the colors.

The scattering of the colored, in particular dyed, carbohydrate particles on the surface of the extruded shaped chewing-gum body, as provided for in the invention, therefore significantly reduces the amount of colored carbohydrate particles to be used or colored components to be used compared to a method in which colored components are incorporated into the entire chewing gum core mass. This is because, according to the invention, the colored carbohydrate particles are only introduced into the areas of the chewing gum core mass that are visible from the outside through the transparent coating, i. e., the surface of the shaped chewing-gum body.

Furthermore, the chewing gum obtained with the aid of the present method is organoleptically and sensorially particularly appealing, since the colored carbohydrate particles scattered on the chewing gum core mass and rolled into the latter improve the crunchiness of the chewing gum. This is achieved in that the colored carbohydrate particles, which are quite large with a particle diameter of 0.2 to 2 mm, form an additional crystalline, crunchy intermediate layer (hereinafter also referred to as the crunchy intermediate layer) on the surface of the chewing gum core and below the crunchy sugar-coated surface layer. The colored carbohydrate particles preferably form a crunchy intermediate layer with a height of 0.2 to 2 mm. The method according to the invention therefore leads to producing transparently sugar-coated chewing gum, comprising a chewing gum core containing at least a first carbohydrate and a transparent sugar-coated surface layer containing at least a second carbohydrate, the transparent sugar-coated surface layer enveloping this chewing gum core, with one surface of the chewing gum core being formed as a crunchy intermediate layer with a height of 0.25 to 2 mm, which has colored carbohydrate particles and which is enveloped by the sugar-coated surface layer containing the second carbohydrate.

In a particularly preferred embodiment, the transparency or the crunchiness or the transparency and crunchiness of the chewing gum provided according to the invention remain particularly stable, even over a longer period of time.

In a first step a), the method provides for chewing gum core components, in particular at least one chewing gum base and at least one first carbohydrate, as well as colored carbohydrate particles with a particle diameter of 0.2 to 2 mm and a transparent sugar-coating medium containing at least one second carbohydrate.

In method step b), the method according to the present invention provides for the chewing gum core components provided in method step a), in particular at least one chewing gum base and at least one first carbohydrate, to be mixed and kneaded. Conventional mixing and/or kneading devices can be used for this.

The at least one chewing gum base is preferably water-insoluble and can contain elastomers, waxes, fats or oils, fillers and other customary components. The at least one chewing gum base is preferably a commercially available chewing gum base. In a preferred embodiment of the present invention, a mixture of two or more different chewing gum bases is used.

Most preferably, the chewing gum base is white or beige. However, it can also be provided that the chewing gum base is colored, in particular dyed with a food coloring.

The chewing gum core mass obtained in method step b) particularly preferably contains 20 to 40% by weight, preferably 25 to 37% by weight, particularly preferably 30 to 35% by weight chewing gum base (based on the total dry matter of the chewing gum core components).

The chewing gum core mass obtained in method step b) also preferably contains 40 to 70% by weight, preferably 50 to 60% by weight, particularly preferably 55 to 65% by weight of the at least one first carbohydrate (based on the total dry matter of the chewing gum core components).

In a preferred embodiment of the present invention, the at least one first carbohydrate that is mixed and kneaded with the chewing gum base in method step b) is a polyol, in particular a sugar alcohol, in particular a di- or monosaccharide alcohol. In particular, the at least one first carbohydrate is a polyol selected from the group consisting of isomalt, sorbitol, xylitol, hydrogenated starch hydrolyzate, in particular maltitol syrup, maltitol, mannitol, erythritol, lactitol, Isomalt ST, Isomalt GS, 1,1-GPM, 1,6-GPS, 1,1-GPS and combinations thereof.

The at least one first carbohydrate is particularly preferably isomalt, in particular Isomalt ST or Isomalt GS.

In a particularly preferred embodiment, the at least one first carbohydrate is a mixture of at least two first carbohydrates, for example a mixture of two, three, four or five different first carbohydrates.

According to the invention, it can also preferably be provided to use at least two, at least three or at least four, in particular precisely two, three or four, different first carbohydrates.

These are preferably all polyols, in particular sugar alcohols, in particular mono- or disaccharide alcohols, in particular selected from the group consisting of isomalt, sorbitol, xylitol, hydrogenated starch hydrolyzate, in particular maltitol syrup, maltitol, mannitol, erythritol, lactitol, Isomalt ST, Isomalt GS, 1,1-GPM, 1,6-GPS, 1,1-GPS, and combinations thereof. According to the invention, one of the at least two, at least three or at least four first carbohydrates is isomalt, in particular Isomalt ST or Isomalt GS.

At least two first carbohydrates, in particular polyols, are preferably used as chewing gum core components. Sorbitol and isomalt or maltitol syrup, in particular maltitol and isomalt, are particularly preferably used as the first two carbohydrates. In a particularly preferred embodiment, the at least one first carbohydrate is a mixture of two first carbohydrates, in particular isomalt, in particular Isomalt ST, and maltitol syrup, in particular maltitol.

The chewing gum core mass obtained in method step b) particularly preferably contains 40 to 70% by weight, preferably 50 to 60% by weight, particularly preferably 55 to 65% by weight of the first two carbohydrates (based on the total dry matter of the chewing gum core components).

In a particularly preferred embodiment, the at least one first carbohydrate is a mixture of three first carbohydrates, in particular isomalt, in particular Isomalt ST, maltitol syrup, in particular maltitol and sorbitol.

The chewing gum core mass obtained in method step b) also preferably contains 40 to 70% by weight, preferably 50 to 60% by weight, particularly preferably 55 to 65% by weight of the at least three first carbohydrates (based on the total dry matter of the chewing gum core components).

The chewing gum core mass obtained in method step b) preferably contains isomalt. In a preferred embodiment of the present invention, the at least one first carbohydrate that is mixed and kneaded with the chewing gum base in method step b) is in powder form. However, it can also be provided that the at least one first carbohydrate is used in dissolved form or in the form of a syrup, i. e., in suspended form, in particular in dissolved form or suspended in water.

The chewing gum core mass obtained in method step b) preferably contains at least 10% by weight, preferably at least 15% by weight, preferably at least 20% by weight, preferably at least 25% by weight, preferably at least 30% by weight isomalt as the first or as one of the at least two or more first carbohydrates (based on the total dry matter of the chewing gum core components).

The chewing gum core mass obtained in method step b) particularly preferably contains at most 15% by weight, preferably at most 20% by weight, preferably at most 25% by weight, preferably at most 30% by weight, preferably at most 35% by weight isomalt as the first or as one of at least two or more first carbohydrates (based on the total dry matter of the chewing gum core components).

In a particularly preferred embodiment, the chewing gum core mass obtained in method step b) has 10 to 35% by weight, in particular 15 to 30% by weight, in particular 17 to 28% by weight, in particular 25% by weight isomalt, in particular Isomalt ST as the first or as one of the at least two or more first carbohydrates (based on the total dry matter of the chewing gum core components).

The chewing gum core mass obtained in method step b) particularly preferably contains at most 15% by weight, preferably at most 20% by weight, preferably at most 25% by weight, preferably at most 30% by weight, preferably at most 35% by weight, of sorbitol as one of the at least two or more first carbohydrates (based on the total dry matter of the chewing gum core components).

Particularly preferably, the chewing gum core mass obtained in method step b) contains at most 8% by weight, preferably at most 9% by weight, preferably at most 10% by weight, preferably at most 11% by weight, preferably at most 12% by weight of maltitol, in particular maltitol syrup, as one of the at least two or more first carbohydrates (based on the total dry matter of the chewing gum core components).

According to the invention it can be provided that none, one, two or all three of the first carbohydrates are in powder form. Provision can also be made for none, one, two or all three of the first carbohydrates to be present in dissolved or suspended form as a syrup. In a preferred embodiment, the chewing gum core mass is sugar-free.

In one embodiment, however, it can also be provided that the at least one first carbohydrate is a sugar, in particular in the form of sucrose, isomaltulose, glucose, fructose or lactose, preferably in combination with a sugar alcohol, in particular isomalt, as a further first carbohydrate.

Furthermore, it can be provided according to the invention that the at least one first carbohydrate is isomaltulose, preferably in combination with a sugar alcohol, in particular isomalt, as a further first carbohydrate.

In a particularly preferred embodiment, apart from sugar alcohols and intensive sweeteners, the chewing gum core mass contains no other sweetening substances adding mass to the chewing gum body, in particular no other sweetening substances. In a particularly preferred embodiment of the present invention, apart from sugar alcohols, the chewing gum core mass contains no other sweetening substances adding mass to the chewing gum body, in particular no other sweetening substances. In a particularly preferred embodiment of the present invention, apart from isomalt and intense sweeteners, the chewing gum core mass does not contain any other sweetening substances adding mass to the chewing gum body, in particular no other sweetening substances. In a particularly preferred embodiment of the present invention, apart from isomalt, the chewing gum core mass does not contain any other sweetening substances adding mass to the chewing gum body, in particular no other sweetening substances.

In a preferred embodiment of the present invention, in addition to the at least one chewing gum base and the at least one first carbohydrate, other chewing gum core components can be used, which are preferably selected from the group consisting of taste producing substances, colorings, processing aids such as release agents or lubricants, intense sweeteners, flavoring substances and combinations from that.

In a preferred embodiment, the intense sweetener is selected from the group consisting of aspartame, acesulfame-K, sucralose, saccharin, glycyrrhizin, thaumatin, neohesperidin dihydrochalcone, cyclamate, stevia extract, steviol glycosides, stevioside, rebaudioside A, monellin, alitame, and combinations thereof. The intensive sweetener aspartame and/or acesulfame-K is particularly preferred.

The chewing gum core mass obtained in method step b) particularly preferably contains 0.01 to 0.3% by weight, preferably 0.05 to 0.25% by weight, preferably 0.1 to 0.2% by weight of intensive sweetener (based on the total dry matter of the chewing gum core components).

Flavoring substances within the meaning of the present invention can be natural, nature-identical or artificial flavoring substances, in particular plant or fruit extracts, essential oils or combinations thereof. Particularly preferred flavoring substances are selected from the group consisting of menthol, peppermint, cinnamon, fruit flavors, and combinations thereof.

In a preferred embodiment, the flavoring substance is peppermint flavoring or menthol flavoring.

In a particularly preferred embodiment, the chewing gum core mass obtained in method step b) contains 0.1 to 5% by weight, in particular 0.5 to 4% by weight, in particular 1 to 3.3% by weight, in particular 3% by weight flavoring substances.

The mixing and kneading of method step b) preferably take place at a temperature of 18 to 30° C., in particular 19 to 25° C., in particular at room temperature. After completion of the mixing and kneading of the chewing gum core components provided in step b) of the present method, a homogeneous chewing gum core mass is preferably obtained.

The chewing gum core mass is extruded in the subsequent method step c). A conventional extruder can be used for this. Extruding the chewing gum core mass preferably leads to obtaining a shaped chewing-gum body, in particular a chewing gum strand, in particular a flat chewing gum strand. The chewing gum core mass is preferably extruded at a temperature of from 35 to 50° C., preferably from 40 to 45° C.

In the subsequent method step d), the shaped chewing-gum body obtained in method step c) is scattered with colored, in particular dyed, carbohydrate particles. This means in particular that the colored, in particular dyed, carbohydrate particles are scattered on a surface, preferably a surface of the extruded shaped chewing-gum body that faces upwards—seen from the support surface of the extruded shaped chewing-gum body. The colored carbohydrate particles preferably stick to the surface of the extruded shaped chewing-gum body and are then rolled into a surface of the shaped body.

In a particularly preferred embodiment, all surfaces, i. e. the entire surface of the shaped body, can be scattered with colored, in particular dyed, carbohydrate particles. In another embodiment of the present invention, provision can be made for scattering only one surface of a plurality of surfaces of the extruded shaped chewing-gum body. According to the invention, in a particularly preferred embodiment, the procedure can be to turn the shaped body onto one surface after colored carbohydrate particles were first scattered on a surface, and to scatter colored carbohydrate particles on at least one further surface in at least one further scattering step, so that several or all surfaces of the shaped body are scattered with colored carbohydrate particles. In a particularly preferred embodiment, it is also possible to scatter the extruded shaped chewing-gum body with colored carbohydrate particles from different directions, optionally also from below.

In a particularly preferred embodiment of the present invention, the proportion of colored carbohydrate particles is 3 to 20% by weight, preferably 7 to 17% by weight, preferably 10 to 15% by weight of the total chewing gum core mass (based on the total chewing gum core mass). A proportion of only 3 to 20% by weight, in particular 7 to 17% by weight, preferably 10 to 15% by weight, in particular 7% by weight, of the colored carbohydrate particles (based on the entire chewing gum core mass) present on a surface of a heterogeneously structured chewing gum core advantageously leads to 20% of the surface being covered so that a particularly distinct color effect is already achieved with a small amount of colored carbohydrate particles.

A comparatively small amount of colored, in particular dyed, carbohydrate particles is therefore preferably used in relation to the amount of chewing gum mass used. Because the colored carbohydrate particles are not mixed with the chewing gum mass according to the invention, but are scattered on a surface of the extruded shaped chewing gum body and then rolled into the surface, a maximum color effect is achieved with a comparatively small amount of colored carbohydrate particles, since all carbohydrate particles are also visible on the surface of the chewing gum.

The implementation of the method according to the invention preferably leads to a specific surface of the shaped chewing-gum body having a color effect, which is achieved by the colored carbohydrate particles which are scattered on the surface. In particular, a dotted, dabbed or spotted color effect is achieved by the colored carbohydrate particles.

In a preferred embodiment, at least 80% by weight, preferably at least 85% by weight, preferably at least 90% by weight, preferably at least 95% by weight, preferably 100% by weight of the colored carbohydrate particles provided in method step a) and scattered on a surface of the shaped chewing-gum body in method step d) (based on the total dry matter of the colored carbohydrate particles) have a particle diameter of 0.2 to 2 mm, preferably 0.3 to 1.8 mm, preferably 0.4 to 1.7 mm, preferably 0.5 to 1.6 mm, preferably 0.6 to 1.5 mm, preferably 0.7 to 1.4 mm, in particular 0.8 to 1.3 mm.

In a preferred embodiment, at least 90% of the colored carbohydrate particles, in particular isomalt particles, have a particle diameter of 0.8 to 1.3 mm, in particular 0.9 to 1.25 mm.

In a particularly preferred embodiment of the present invention, the colored, in particular dyed, carbohydrate particles are polyol particles. In particular, the colored carbohydrate particles are polyol particles, the polyol being a sugar alcohol, in particular a di- or monosaccharide sugar alcohol, in particular selected from the group consisting of isomalt, sorbitol, xylitol, maltitol, mannitol, erythritol, lactitol, Isomalt ST, Isomalt GS, 1,1-GPM, 1,6-GPS, 1,1-GPS and combinations thereof. The colored carbohydrate particles are particularly preferably isomalt particles, in particular Isomalt ST particles or Isomalt GS particles.

The colored, in particular dyed, carbohydrate particles, in particular isomalt particles, can preferably contain at least one coloring. In a particularly preferred embodiment, the colored carbohydrate particles contain at least one coloring that differs from the coloring(s) optionally contained in the chewing gum base.

The colored, in particular dyed, carbohydrate particles, in particular isomalt particles, can preferably contain at least one flavoring substance. In a particularly preferred embodiment, the colored carbohydrate particles contain at least one flavoring substance which differs from the flavoring substance(s) optionally contained in the chewing gum base.

In a preferred embodiment of the present invention, all of the colored carbohydrate particles scattered on in method step d) have the same color. However, it can also be provided that a mixture of differently colored carbohydrate particles, each having a different color, is used, so that a mixture of at least two or more differently colored carbohydrate particles is used.

In a preferred embodiment, the colored carbohydrate particles are not white. In a preferred embodiment, the colored carbohydrate particles are not beige. In a preferred embodiment of the present invention, the shaped chewing-gum body is white and the colored carbohydrate particles are non-white in color. In a particularly preferred embodiment of the present invention, the shaped chewing-gum body is beige and the colored carbohydrate particles are non-beige in color.

Furthermore, it can also preferably be provided that the colored carbohydrate particles are white and are scattered on a shaped chewing-gum body that is not white.

In the subsequent method step e) of the present method, the colored carbohydrate particles scattered on a surface of the extruded shaped chewing-gum body are rolled into the surface. This is preferably done in such a way that little pressure is exerted. The particles are pressed only slightly, preferably superficially, into the chewing gum core mass. The carbohydrate particles preferably protrude with only a small proportion of their average diameter, in particular 1 to 50%, in particular 10 to 40%, in particular 15 to 35%, in particular 20 to 30% of their average diameter into the chewing gum core mass of the shaped chewing-gum body.

The colored, in particular dyed, carbohydrate particles, in particular all scattered colored carbohydrate particles, are completely visible on the background of the chewing gum core mass, preferably in their entirety, due to their color deviating from that of the chewing gum mass.

However, it can also be provided that greater pressure is exerted when the colored carbohydrate particles are rolled in, so that the particles are pressed deeper into the chewing gum core mass and are only partially visible on the background of the chewing gum core mass. The carbohydrate particles preferably protrude with a larger proportion of their average diameter, in particular 50 to 100%, in particular 60 to 90%, in particular 65 to 85%, in particular 70 to 80% of their average diameter into the chewing gum core mass of the shaped chewing-gum body.

In the present method, the colored carbohydrate particles are not mixed with the chewing gum core mass.

After method step e) of the method according to the invention, i. e., the rolling of the shaped chewing-gum body on which colored carbohydrate particles are scattered, a conditioning step can optionally be provided in which the rolled shaped chewing-gum body is cooled to room temperature.

After method step e) or the optionally subsequent conditioning step, the shaped chewing-gum body on which colored carbohydrate particles are scattered and into which colored carbohydrate particles are rolled is cut in method step f) of the present method, in particular such that individual chewing gum cores, in particular heterogeneously structured chewing gum cores, are obtained. The heterogeneously structured chewing gum cores are particularly preferably cut in the form of a strip, pillow, stick or disc.

In method step g) of the present method, the heterogeneously structured chewing gum cores obtained in method step f) are sugar-coated with the transparent sugar-coating medium, in particular a transparent sugar-coating solution.

Method step g) therefore leads to the formation of a sugar-coated surface layer enveloping the heterogeneously structured chewing gum core obtained in step f).

In a particularly preferred embodiment of the present invention, the heterogeneously structured chewing gum core is sugar-coated with the transparent sugar-coating medium in method step g), in particular sugar-coating medium is applied in method step g1) and dried in method step g2). The application in method step g1) and subsequent drying in method step g2) of the sugar-coating medium, also referred to here as a cycle, can take place more than once, in particular for example five to a hundred times.

In a preferred embodiment of the present invention, method step g) is carried out in at least two cycles, preferably 5 to 100 cycles, preferably 10 to 95 cycles, in particular 20 to 80 cycles. Each individual cycle comprises a step of applying (g1)) sugar-coating medium and a subsequent drying step (g2)) and preferably leads to the formation of a sugar-coating layer.

In a preferred embodiment, the sugar-coating medium is applied to the chewing gum cores in method step g1) by being sprayed on the chewing gum core.

In a particularly preferred embodiment, method step g1) takes place at a temperature of 30 to 75° C., in particular 40 to 70° C., in particular 50 to 70° C., in particular 55 to 65° C., in particular 60° C.

In a particularly preferred embodiment, the chewing gum cores sugar-coated with the transparent sugar-coating medium, in particular the transparent sugar-coating solution, are dried in at least one drying step, namely a method step g2), in the course of method step g).

The at least one drying step g2) can be carried out at a temperature of 18 to 40° C., in particular 20 to 35° C., in particular 22 to 30° C., in particular while using warm drying air. In a preferred embodiment, a relative humidity of 5 to 40%, in particular 5 to 20%, in particular <20%, in particular <18%, in particular <15%, is set in method step g2).

In a preferred embodiment of the present invention, the at least one second carbohydrate contained in the transparent sugar-coating medium is a polyol, in particular a sugar alcohol, in particular a di- or monosaccharide alcohol.

In a particularly preferred embodiment, the second carbohydrate is crystalline. In a particularly preferred embodiment, the second carbohydrate is semi-crystalline.

In a particularly preferred embodiment, the at least one second carbohydrate is a polyol selected from the group consisting of isomalt, sorbitol, xylitol, hydrogenated starch hydrolyzate, in particular maltitol syrup, maltitol, mannitol, erythritol, lactitol, Isomalt ST, Isomalt GS, 1,1 GPM, 1,6 GPS, 1,1 GPS, and combinations thereof. The at least one second carbohydrate contained in the transparent sugar-coating medium is preferably isomalt, preferably with a ratio of 1,6-GPS (6-O-α-D-glucopyranosyl-D-sorbitol) to 1,1-GPM (1-O-α-D-glucopyranosyl-D-mannitol) from 70 to 80% by weight of 1,6-GPS to 30 to 20% by weight of 1,1-GPM (in each case based on the total dry matter of 1,6-GPS to 1,1-GPM of isomalt).

It can also be provided that the at least one second carbohydrate is a mixture of at least two second carbohydrates, for example a mixture of two, three, four or five different second carbohydrates.

In a particularly preferred embodiment, the second carbohydrate is isomalt, in particular Isomalt GS.

In a particularly preferred embodiment it is provided that the isomalt-containing sugar-coating medium contains 55 to 75% by weight, in particular 60 to 75% by weight, in particular 65 to 75% by weight, in particular 70 to 75% by weight, in particular 55 to 70% by weight, in particular 55 to 65% by weight, in particular 55 to 60% by weight, in particular 60 to 70% by weight (based on the total mass of the sugar-coating medium) isomalt, in particular Isomalt GS.

In a particularly preferred embodiment, the sugar-coating medium is a sugar-coating solution or a sugar-coating syrup. In a particularly preferred embodiment, the sugar-coating medium is a sugar-coating solution. In a particularly preferred embodiment, the sugar-coating medium, in particular the sugar-coating solution or the sugar-coating syrup, is an aqueous sugar-coating solution or an aqueous sugar-coating medium.

In a particularly preferred embodiment, the isomalt-containing sugar-coating medium is an aqueous isomalt-containing sugar-coating medium, in particular a, preferably aqueous, isomalt-containing sugar-coating solution.

In a particularly preferred embodiment of the present invention, the transparent sugar-coating solution comprises, in particular it consists of, isomalt, in particular Isomalt GS, and water, in particular demineralized water.

In a particularly preferred embodiment, it is provided that the sugar-coating medium, in particular the isomalt-containing sugar-coating medium, has a dry substance content of 55 to 80% by weight, in particular 60 to 75% by weight, in particular 65 to 73% by weight, in particular 60 to 73% by weight, in particular 62 to 71% by weight, in particular 60 to 70% by weight (based on the total mass of the sugar-coating medium).

In a particularly preferred embodiment of the present invention, the sugar-coating medium, in particular the isomalt-containing sugar-coating medium, has at least one other substance selected from the group consisting of carbohydrates, sugar alcohols, sugar substitutes, high-intensity sweeteners, lipids, edible acids, amino acids, colorings, dietary fibers, proteins, taste producing substances, minerals, metal oxides, vitamins and combinations thereof.

In a particularly preferred embodiment, the sugar-coating medium, in particular the isomalt-containing sugar-coating medium, has 0.1 to 1% by weight, preferably 0.2 to 0.7% by weight, in particular 0.2 to 0.6% by weight (based on the total mass of the sugar-coating medium) of the at least one other substance.

In a particularly preferred embodiment, the sugar-coating medium, in particular the sugar-coating solution, and the sugar-coated surface layer obtained are sugar-free. In a particularly preferred embodiment of the present invention, the sugar-coating medium, in particular the sugar-coating solution and the sugar-coated surface layer obtained, is sugar-free and contains isomalt, in particular Isomalt GS, as the only sweetening component.

The transparent sugar-coating medium used in the present method particularly preferably contains no colorings and/or opacifiers, in particular the transparent sugar-coating medium does not contain any titanium dioxide, calcium carbonate, starch and/or calcium phosphate. The sugar-coating medium is therefore preferably coloring-free. This advantageously means that the chewing gum cores sugar-coated with such a sugar-coating medium have a transparent sugar-coated surface layer. Advantageously, the colored carbohydrate particles previously scattered on a surface of the extruded shaped chewing-gum body are thus visible through the sugar-coated surface layer.

In a preferred embodiment of the present invention, the transparent sugar-coating medium contains no emulsifiers, sorbitol or xylitol.

In a preferred embodiment of the present invention, the transparent sugar-coating medium contains at most 3% by weight, preferably at most 2% by weight, particularly preferably at most 1% by weight, or no binder (based on the total dry matter of the sugar-coating medium).

In a preferred embodiment of the present invention, the transparently sugar-coated chewing gum obtained in method step h) comprises 15 to 50% by weight, preferably 20 to 40% by weight, preferably 25 to 35% by weight of sugar-coated surface layer (based on the total dry matter of the sugar-coated chewing gum).

In a preferred embodiment of the present invention, the sugar-coated surface layer is a hard sugar-coated surface layer.

In a particularly preferred embodiment, the sugar-coated surface layer obtained in method step g) has at least 90% by weight, at least 92% by weight, at least 94% by weight, at least 95% by weight, at least 96% by weight, at least 97% by weight, at least 98% by weight, at least 99% by weight of the at least one second carbohydrate, in particular polyol, in particular di- or monosaccharide alcohol, in particular isomalt (in each case based on the total weight of the sugar-coated surface layer).

In a particularly preferred embodiment, the sugar-coated surface layer obtained in method step g) has at most three, at most two, at most one, and in particular no binder (based on the total mass of the sugar-coated surface layer).

In a particularly preferred embodiment, the water content of the sugar-coated surface layer obtained in method step g), in particular hard sugar-coated surface layer, is from 0.05 to 2.5% by weight, in particular 0.1 to 2% by weight, in particular 0.5 to 1.5% by weight of water (in each case based on the total weight of the sugar-coated surface layer).

In a preferred embodiment, the method according to the invention comprises, in particular consists of, method steps a), b), c), d), e), f), g) and h), preferably in this order.

In a preferred embodiment, the method according to the invention comprises, in particular consists of, method steps a), b), c), d), e), conditioning step f), g) and h), preferably in this order.

In a particularly preferred embodiment, method step b) is carried out in a mixing and kneading machine, method step c) in an extruder, method step d) in or on a transport device with a support surface for the extruded shaped chewing-gum body, method step e) in a rolling device, method step f) in a cutting device, method step g) in a sugar-coating apparatus, in particular an automatic sugar-coating apparatus, for example a Driacoater, and method step g1) optionally in a dryer or the sugar-coating apparatus.

The present invention also relates to a transparently sugar-coated chewing gum that can be produced, in particular that is produced using the method according to the invention.

According to the present invention, a hard sugar-coated chewing gum enveloped by a transparent hard sugar-coated surface layer is preferably obtained.

In a particularly preferred embodiment of the present invention, the sugar-coated surface layer is particularly stable when put in storage.

In a particularly preferred embodiment, the transparency of the transparent sugar-coated surface layer remains stable over a long period of time.

In a particularly preferred embodiment, the chewing gum that is obtained, which is preferably hard sugar-coated and sugar-coated with a transparent sugar-coated surface layer, is also particularly crunchy.

In a particularly preferred embodiment, the crunchiness is retained even after prolonged storage.

In particular, the invention relates to a sugar-coated chewing gum, having a transparent sugar-coated surface layer, in particular hard sugar-coated surface layer, enclosing the heterogeneously structured chewing gum core, which can be produced in particular by a method according to the invention.

The present invention relates in particular to a transparently sugar-coated chewing gum comprising a chewing gum core containing at least one first carbohydrate and a transparent sugar-coated surface layer containing at least a second carbohydrate enveloping this chewing gum core, with one surface of the chewing gum core being formed as a crunchy intermediate layer with a depth of 0.2 to 2 mm comprising colored carbohydrate particles.

In a particularly preferred embodiment of the present invention, the chewing gum core of the transparently sugar-coated chewing gum produced by the method according to the invention is sugar-free. In a particularly preferred embodiment of the present invention, the transparent sugar-coated surface layer of a transparently sugar-coated chewing gum produced according to the invention and enveloping a sugar-free or sugar-containing, in particular sugar-free, heterogeneously structured chewing gum core is sugar-free. In a particularly preferred embodiment of the present invention, the colored carbohydrate particles present in the transparently sugar-coated chewing gum produced according to the invention are sugar-free. In a particularly preferred embodiment of the present invention, the transparently sugar-coated chewing gum produced by the method according to the invention is completely sugar-free.

In connection with the present invention, “isomalt” means a mixture of 6-O-α-D-glucopyranosyl-D-sorbitol (1,6-GPS) and 1-O-α-D-glucopyranosyl-D-mannitol (1,1-GPM) and optionally 1-O-α-D-glucopyranosyl-D-sorbitol (1,1-GPS), in particular Isomalt GS or Isomalt ST.

In connection with the present invention, “Isomalt ST” is understood to mean a mixture of 53 to 47% by weight of 1,6-GPS and 47 to 53% by weight of 1,1-GPM (based on the dry weight of Isomalt ST).

In connection with the present invention, “Isomalt GS” is a mixture of 70 to 80% by weight, in particular 72 to 78% by weight, preferably 75% by weight, 1,6-GPS and 20 to 30% by weight, in particular 22 to 28% by weight, in particular 25% by weight, of 1,1-GPM (in each case based on the dry substance of Isomalt GS).

If, in connection with the present invention, more than one surface of a shaped chewing-gum body is mentioned, this means partial surfaces in relation to the overall surface of the shaped chewing gum body, in particular those partial surfaces that are characterized by the geometry of the extruded shaped chewing-gum body, in particular by edges, corners or roundings, represent geometrically delimitable partial surfaces of a total surface.

In connection with the present invention, “colored carbohydrate particles” are understood to be carbohydrate particles that have a color that is different from the color of the extruded shaped chewing-gum body, in particular the surface of the extruded shaped chewing-gum body, in particular the chewing gum core.

According to the invention, the colored carbohydrate particles are therefore of a color that differs from the color of the surface of the chewing gum core.

For the purposes of the present invention, colors can be, for example, red, green, blue, cyan, magenta, violet, pink, rose, orange, yellow, gray, brown, black, white, or shades thereof.

In connection with the present invention, a “transparent sugar-coating medium” means a solution or suspension (also known as a syrup), in particular a solution or in particular a syrup, in particular an aqueous solution or an aqueous suspension, which is transparent in the form of the medium and which, after application to a chewing gum core and drying, creates a transparent sugar-coated surface layer.

In connection with the present invention, crunchiness is understood to mean an organoleptic and sensory characteristic that a consumer experiences in particular through the crunchy mouthfeeling of the chewing gum in the oral cavity, in particular a specific splintering behavior and an associated noise.

In connection with the present invention, the term “transparent” means light transmission. In particular, the transparency of the sugar-coated surface layer according to the invention has a relative value of 5 to 9, preferably 6 to 8, when it is evaluated on a scale of 0 to 10 and the value 0 is “completely opaque” and the value 10 is equivalent to “completely transparent, vitreous.”

In connection with the present invention, a “sugar-coated surface layer” is understood to mean the entirety of all sugar-coating layers possibly applied in different phases and cycles, in particular at least one sugar-coating layer applied by sugar-coating, in particular several sugar-coating layers.

If quantitative information, in particular percentages, of components of a product or a composition are indicated in connection with the present invention, these add up to 100% of the composition and/or the product, unless explicitly indicated otherwise or unless they are perceived to be different by a person skilled in the art, together with the other components of the composition or the product explicitly indicated or obvious for a person skilled in the art.

If, in connection with the present invention, it is mentioned that a component is “present,” “contained” or “comprised” in an amount of 0% by weight, this means that the respective component is not present in a measurable amount, in particular that it is not present at all.

If, in connection with the present invention, the first and second decimal places or the second decimal place are/is not specified in a number, these are/is to be set to 0.

Further advantageous embodiments result from the dependent claims.

The invention is explained in more detail using the following example and the accompanying figures.

The figures show:

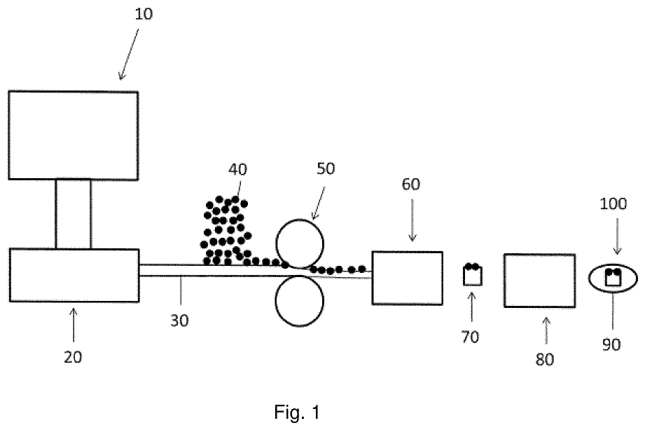

FIG. 1 schematically shows the implementation of the method according to the invention.

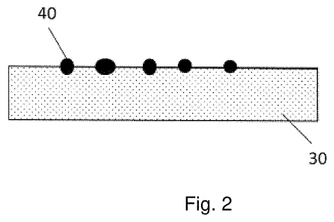

FIG. 2 schematically shows the colored carbohydrate particles that are scattered on and subsequently rolled into the surface of an extruded shaped chewing-gum body.

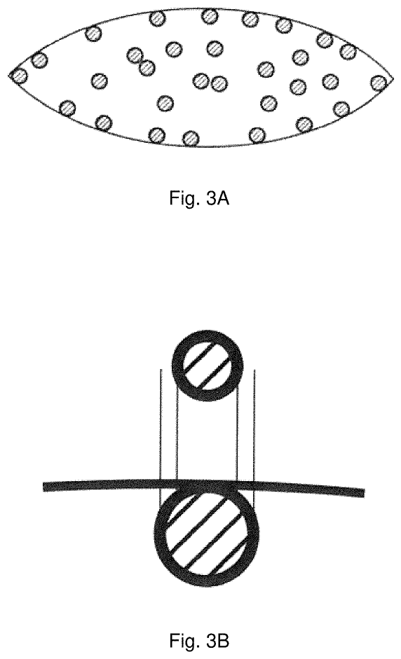

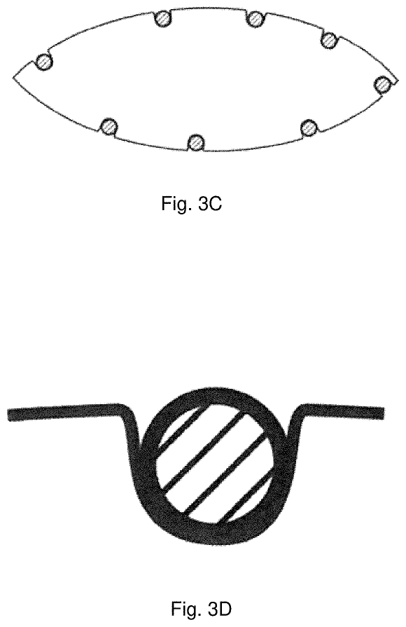

FIG. 3 schematically shows a comparison of the visual effect of colored carbohydrate particles (3A, 3B) incorporated into the chewing gum core mass and colored carbohydrate particles (3C, 3D) scattered on and rolled into the surface of the shaped chewing-gum body.

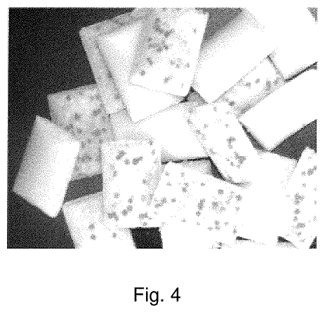

FIG. 4 shows transparently sugar-coated chewing gum obtained according to the invention.

### EXAMPLES

The following chewing gum core components were provided for the production of transparently sugar-coated chewing gum, having a heterogeneously structured chewing gum core and a transparent sugar-coated surface layer enveloping this core.

### Chewing Gum Core Components:

| | |
|---|---|
| Chewing Gum Base “TFL3” (Euobase) | 16.00% by weight |
| Chewing Gum Base “TULI Mod 2” (Euobase) | 16.00% by weight |
| Sorbitol (P60, Roquette, average particle | 29.20% by weight |
| diameter 230 μm) | |
| Isomalt ST PF (Beneo) | 25.00% by weight |
| Maltitol Syrup (Lycasin 80/55) (Roquette) | 10.60% by weight |
| Peppermint Flavor | 1.50% by weight |
| Menthol Flavor | 1.50% by weight |
| Acesulfame-K | 0.10% by weight |
| Aspartame | 0.10% by weight |

In addition, Isomalt ST-PNC particles were provided. Isomalt ST-PNC particles are Isomalt ST particles with a particle diameter of 0.8 to 1.25 mm. The Isomalt ST-PNC particles were colored with color solution in a sugar-coating pan with constant agitation. In order to obtain green-colored particles, 12.5 kg of Isomalt ST-PNC particles were colored with 600 g of 0.05% “Bright Green P-WS” (419167-0010, Sensient). In order to obtain blue-colored particles, 12.5 kg of Isomalt ST-PNC particles were colored with 600 g of 0.05% “Spirulina Blue P-WS” (409422-0001, Sensient). The color solutions were poured onto a moving bed of Isomalt ST-PNC particles. Four other Isomalt ST-PNC particle sets of different colors were produced analogously.

In addition, a transparent sugar-coating solution was provided. This contained 65% by weight of Isomalt GS and 35% by weight of demineralized water.

The chewing gum core components were mixed at room temperature, kneaded and then extruded at a temperature of 40 to 45° C. in the form of a flat, beige-colored extruded strand (web).

The colored Isomalt-PNC particles (mixture of six different Isomalt-PNC particles, each of a different but not beige color) were scattered on one surface of the extruded chewing gum strand (extruded chewing gum shaped body), the scattered shaped chewing-gum bodies were then rolled and cut into pillow shapes, so that heterogeneously structured chewing gum cores were obtained. Based on the total mass of the entire chewing gum core, the amount of colored Isomalt-PNC particles was 7%.

The pillow-shaped, heterogeneously structured chewing gum cores obtained in this way were 19 mm long, 12 mm wide and 6 mm high, with a total surface area of 530 mm² and a volume of 960 mm³. In the subsequent conditioning step, the chewing gum cores obtained in this way were cooled to room temperature.

The transparent sugar-coating solution consisting of 65% by weight Isomalt GS and 35% by weight demineralized water was sprayed onto the pillow-shaped chewing gum cores at a temperature of 60° C. in 10 phases and 95 cycles over a total period of 313 minutes and was dried with dry air having a temperature of 25° C. (relative humidity <15%). A phase is a combination of several cycles with approximately the same parameters such as application quantity, distribution time and crystallization or drying time, wherein these phases can have build-up phases and main phases, smoothing phases and growth phases, each of which can comprise several cycles. Based on the total weight of the finished, sugar-coated chewing gum (FIG. 4), the sugar-coated surface layer made up 26.8% by weight.

FIG. 1 schematically shows the implementation of the method according to the invention. Accordingly, the chewing gum core components provided in method step a) are mixed and kneaded in method step b) in a mixing and kneading device 10 shown in FIG. 1 to obtain a chewing gum core mass. The chewing gum core mass transferred from the mixing and kneading device 10 is then extruded in an extruder 20 and an extruded shaped chewing gum body in the form of a flat chewing gum strand 30 is obtained. Colored carbohydrate particles 40 are scattered on this extruded shaped chewing-gum body 30, and the scattered carbohydrate particles 40 are rolled into the surface of the extruded shaped chewing-gum body 30 in a rolling device 50, resulting in the structure shown in FIG. 2 with colored carbohydrate particles 40 rolled into the surface of the shaped chewing-gum body 30. In a cutting device 60, the rolled shaped chewing-gum body 30 is cut after optionally a conditioning step has taken place, so that heterogeneously structured chewing gum cores 70 are obtained, which are then sugar-coated in a sugar-coating apparatus 80 using a transparent sugar-coating solution, so that sugar-coated chewing gum 100 having a transparent sugar-coated surface layer 90 having a heterogeneously structured core is obtained.

Considering a pillow surface area of about 530 mm², a pillow volume of about 960 mm³, an average Isomalt ST-PNC particle diameter of 1 mm and a resulting cross-sectional area of the particles of 0.785 mm², about 135 Isomalt ST-PNC particles are required to cover 20% of the surface area of a chewing-gum core pillow. This applies when—as provided according to the invention—the particles are pressed into the chewing gum core from the outside, so that essentially the entire hemisphere of the Isomalt ST-PNC particle is visible from the outside.

If, in a procedure, which is not in accordance with the invention, the same colored Isomalt ST-PNC particles are not scattered on the surface of an extruded shaped chewing-gum body, but rather mixed and kneaded together with the chewing gum core components to obtain a chewing gum core mass (FIG. 3A), the particles are mixed in and only about half of the hemisphere, i. e., the cross-sectional surface, is visible (FIG. 3B) since the chewing gum mass is almost completely opaque. Accordingly, twice as many, i.e., about 270 particles, are required on the surface in order to cover 20% of the surface. The color of these particles does not appear as light as in the method according to the invention because, even if they are close to the surface, they are nevertheless partially covered by the chewing gum mass. In order to achieve a proportion of 270 particles on the surface, the entire chewing gum core must have the same density as the surface, i. e., about 27% of the chewing gum core must consist of colored Isomalt ST-PNC particles, i.e., about 487 particles. Accordingly, about 3.6 times as many particles are required as in the method according to the invention in order to ensure comparable visibility.

FIG. 3A shows the result of a procedure, which is not in accordance with the invention, according to which particles are mixed into the chewing gum core mass, so that the particles that are not on the surface remain invisible. In contrast, FIG. 3C shows the result of the procedure according to the invention, according to which the particles are superficially rolled into the chewing gum core mass and are therefore visible from the outside. FIG. 3B shows in detail that—if the particles are mixed into the mass—only half of the cross-sectional surface, i.e., the hemisphere, is visible, while in the case that the particles are only rolled into the surface of the mass in the procedure according to the invention, the entire cross-sectional surface, i.e., the entire hemisphere (FIG. 3D) is visible.

The localization of the colored Isomalt ST-PNC particles provided according to the invention exclusively on the surface of the chewing gum core results in a crunchy intermediate layer which leads to an advantageous two-stage crunch, i. e., crunchy mouthfeeling.

The procedure according to the invention therefore leads to the provision of visually and organoleptically improved transparently sugar-coated chewing gum (FIG. 4) with heterogeneously colored structured chewing gum cores, with this method advantageously requiring a smaller amount of colored carbohydrate particles in order to achieve a comparable, in particular even improved, optical effect.

1. A method for producing transparently sugar-coated chewing gum, having a heterogeneously structured chewing gum core and a transparent sugar-coated surface layer enveloping this core, comprising the following method steps:
a) providing chewing gum core components, in particular at least one chewing gum base and at least one first carbohydrate, colored carbohydrate particles with a particle diameter of 0.2 to 2 mm, and a transparent sugar-coating medium containing at least one second carbohydrate,
b) mixing and kneading the chewing gum core components to obtain a chewing gum core mass,
c) extruding the chewing gum core mass to obtain an extruded shaped chewing-gum body,
d) Scattering the colored carbohydrate particles on a surface of the extruded shaped chewing-gum body,
e) rolling the shaped chewing-gum body scattered with colored carbohydrate particles,
f) cutting the rolled shaped chewing-gum body obtained in step e) to obtain heterogeneously structured chewing gum cores,
g) sugar-coating the heterogeneously structured chewing gum cores obtained in step f) with the transparent sugar-coating medium and
h) obtaining transparently sugar-coated chewing gum, having a heterogeneously structured chewing gum core.

2. The method according to claim 1, wherein the proportion of the colored carbohydrate particles in the chewing gum core mass is from 3 to 20% by weight (based on the total chewing gum core mass).

3. The method according to claim 1, wherein the colored carbohydrate particles are polyol particles.

4. The method according to claim 1, wherein at least 80% by weight of the colored carbohydrate particles provided in method step a) (based on the total dry matter of the colored carbohydrate particles) have a particle diameter of 0.2 mm to 2 mm, in particular 0.5 to 1.6 mm.

5. The method according to claim 1, wherein the colored carbohydrate particles contain at least one flavoring substance.

6. The method according to claim 1, wherein the chewing gum core mass obtained in method step b) has 40 to 70% by weight of the at least one first carbohydrate (based on the total dry matter of the chewing gum core components).

7. The method according to claim 1, wherein the at least one first carbohydrate is a polyol, in particular isomalt.

8. The method according to claim 1, wherein in addition to the at least one chewing gum base and the at least one first carbohydrate, further chewing gum core components are selected from the group consisting of taste producing substances, colorings, processing aids such as release agents or lubricants, intense sweeteners, flavoring substances and combinations thereof.

9. The method according to claim 8, wherein the intense sweetener is selected from the group consisting of aspartame, acesulfame-K, sucralose, saccharin, glycyrrhizin, thaumatin, neohesperidin dihydrochalcone, cyclamate, stevia extract, steviol glycosides, stevioside, rebaudioside A, monellin, alitame, and combinations thereof.

10. The method according to claim 1, wherein the shaped chewing-gum body is cut in step f) in the form of a strip, pillow, stick or disc.

11. The method according to claim 1, wherein the at least one second carbohydrate contained in the transparent sugar-coating medium is a polyol.

12. The method according to claim 1, wherein the at least one second carbohydrate contained in the transparent sugar-coating solution is isomalt, preferably with a ratio of 1,6-GPS (6-O-α-D-glucopyranosyl-D-sorbitol) to 1,1-GPM (1-O-α-D-glucopyranosyl-D-mannitol) from 70 to 80% by weight 1,6-GPS to 30 to 20% by weight 1,1-GPM (in each case based on the total dry matter of 1,6-GPS to 1,1-GPM of isomalt).

13. The method according to claim 1, wherein method step g) is carried out in at least two cycles, in particular 5 to 100 cycles.

14. The method according to claim 1, in which the transparently sugar-coated chewing gum obtained in method step h) comprises 15 to 50% by weight of sugar-coated chewing gum (based on the total dry matter of the sugar-coated chewing gum).

15. A sugar-coated chewing gum that can be produced with a transparent sugar-coated surface layer enclosing a heterogeneously structured chewing gum core, in particular produced by a method according to claim 1.

16. A transparently sugar-coated chewing gum comprising a chewing gum core containing at least a first carbohydrate and a transparently sugar-coated surface layer containing at least a second carbohydrate enveloping this chewing gum core, wherein one surface of the chewing gum core is designed as a crunchy intermediate layer with a height of 0.2 to 2 mm containing colored carbohydrate particles.
